(19) United States
(12) Patent Application Publication
(10) Pub. No.: US 2022/0348776 A1
(43) Pub. Date: Nov. 3, 2022

(54) INK COMPOSITIONS WITH POLYURETHANE BINDER

(71) Applicant: Hewlett-Packard Development Company, L.P., Spring, TX (US)

(72) Inventors: Zhang-Lin Zhou, San Diego, CA (US); Julia Jiayun ZHOU, San Diego, CA (US); Qianhan YANG, San Diego, CA (US)

(73) Assignee: Hewlett-Packard Development Company, L.P., Spring, TX (US)

(21) Appl. No.: 17/642,293

(22) PCT Filed: Nov. 13, 2019
(86) PCT No.: PCT/US2019/061100

§ 371 Date: Mar. 11, 2022

(51) Int. Cl. C09D 11/32; C09D 11/102; C09D 11/033; C09D 11/037; C09D 11/54; D06P 5/30; D06P 5/00; D06P 1/54; D06P 1/52; B41J 3/407

(52) U.S. Cl. CPC C09D 11/32; C09D 11/102; C09D 11/033; C09D 11/037; C09D 11/54; D06P 5/30; D06P 5/002; D06P 1/54; D06P 1/5285; B41J 3/4078

(57) ABSTRACT

The present disclosure describes ink compositions having a polyurethane binder that can be used for textile printing. In one example, an ink composition can include water, an organic co-solvent, a colorant, and a polyurethane binder. The polyurethane binder can include pre-polymer segments that include polymerized monomers of a diisocyanate, a graft diol, a polymeric diol, and an acid-containing diol. The graft diol can include thioglycerol having a polymer sidechain replacing a hydrogen atom on a sulfur atom of the thioglycerol. The polymer sidechain can include a polymerized monomer of an acrylate ester, a methacrylate ester, a styrene, or a combination thereof. The polyurethane binder can also include chain extenders connecting the pre-polymer segments. The chain extenders can include a polymerized sulfonate-containing diamine.

### BACKGROUND

Inkjet printing has become a popular way of recording images on various media. Some of the reasons include low printer noise, variable content recording, capability of high-speed recording, and multi-color recording. These features can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc. However, the permanence of printed ink on textiles can be an issue.

### BRIEF DESCRIPTION OF DRAWINGS

FIG. 1 schematically depicts an example textile printing system in accordance with the present disclosure;

FIG. 2 schematically depicts another example textile printing system in accordance with the present disclosure; and

FIG. 3 provides a flow diagram for an example method of textile printing in accordance with the present disclosure.

### DETAILED DESCRIPTION

The present disclosure is drawn to ink compositions that include polyurethane binders, textile printing systems that include ink compositions having polyurethane binders, and methods of textile printing with ink compositions that include polyurethane binders. In one example, an ink composition includes water, an organic co-solvent, a colorant, and a polyurethane binder. The polyurethane binder includes pre-polymer segments including polymerized monomers of a diisocyanate, a graft diol, a polymeric diol, and an acid-containing diol. The graft diol includes thioglycerol having a polymer sidechain replacing a hydrogen atom on a sulfur atom of the thioglycerol. The polymer sidechain includes a polymerized monomer of an acrylate ester, a methacrylate ester, a styrene, or a combination thereof. The polyurethane binder also includes chain extenders connecting the pre-polymer segments, wherein the chain extenders include a polymerized sulfonate-containing diamine. In some examples, the polymeric diol can include a first terminal hydroxyl group at a first end of the polymeric diol and a second terminal hydroxyl group at a second end of the polymeric diol. In further examples, the acid-containing diol can be 2,2-bis(hydroxymethyl) propionic acid (DMPA) or 2,2-bis(hydroxymethyl) butyric acid (DMBA). In certain examples, the graft diol can include structure (I):

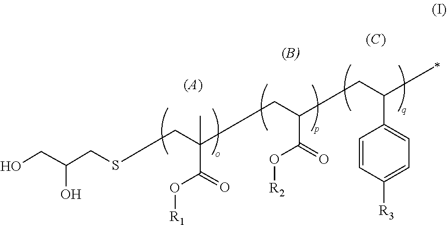

where R₁ is C1-C12 alkyl or C6-C16 cycloalkyl, R₂ is C1-C12 alkyl or C6-C16 cycloalkyl, and R₃ is a H, C1-C12 alkyl or C6-C16 cycloalkyl, where polymerized monomers (A), (B), and (C), if independently present, are polymerized in a random copolymer sidechain, and where o, p, and q are independently 0 to 200, provided that o+p+q is from 5 to 200. In particular examples, the polymer sidechain of the graft diol can be a random copolymer of methyl methacrylate and 2-ethylhexyl acrylate. In other examples, the graft diol can have a weight average molecular weight from 500 Mw to 15,000 Mw. In still further examples, the diisocyanate can include 2,2,4-trimethylhexane-1,6-diisocyanate (TMDI), 2,4,4-trimethylhexane-1,6-diisocyanate (TMDI), isophorone diisocyanate (IPDI), 1,3-bis(isocyanatomethyl)cyclohexane (H6XDI), hexamethylene diisocyanate (HDI), methylene diphenyl diisocyanate (MDI), 4,4′-methylene dicyclohexyl diisocyanate (H12MDI), or a combination thereof. In certain examples, the polyurethane binder can have an acid number from 10 mg KOH/g to 100 mg KOH/g.

The present disclosure also describes textile printing systems. In one example, a textile printing system includes a fabric substrate and an ink composition. The ink composition includes water, an organic co-solvent, a colorant, and a polyurethane binder. The polyurethane binder includes pre-polymer segments including polymerized monomers of a diisocyanate, a graft diol, a polymeric diol, and an acid-containing diol, wherein the graft diol includes thioglycerol having a polymer sidechain replacing a hydrogen atom on a sulfur atom of the thioglycerol, and wherein the polymer sidechain includes a polymerized monomer of an acrylate ester, a methacrylate ester, a styrene, or a combination thereof. The polyurethane binder also includes chain extenders connecting the pre-polymer segments, wherein the chain extenders include a polymerized sulfonate-containing diamine. In some examples, the fabric substrate can include cotton, polyester, silk, nylon, or a blend thereof. In further examples, the graft diol can include structure (I) shown above. The textile printing system can also include a crosslinker composition including a crosslinker that is reactive with the polyurethane binder to crosslink the polyurethane binder after printed in contact with the ink composition on the fabric substrate.

The present disclosure also describes methods of textile printing. In one example, a method of textile printing includes jetting an ink composition onto a fabric substrate. The ink composition includes water, an organic co-solvent, a colorant, and a polyurethane binder. The polyurethane binder includes pre-polymer segments including polymerized monomers of a diisocyanate, a graft diol, a polymeric diol, and an acid-containing diol, wherein the graft diol includes thioglycerol having a polymer sidechain replacing a hydrogen atom on a sulfur atom of the thioglycerol, and wherein the polymer sidechain includes a polymerized monomer of an acrylate ester, a methacrylate ester, a styrene, or a combination thereof. The polyurethane binder also includes chain extenders connecting the pre-polymer segments, wherein the chain extenders include a polymerized sulfonate-containing diamine. In some examples, the method can also include applying a crosslinker composition onto the fabric substrate before jetting the ink composition. In further examples, the fabric substrate can include cotton, polyester, silk, nylon, or a blend thereof. In still further examples, the graft diol can include structure (I) shown above.

It is noted that when discussing the ink compositions, textile printing systems, or the methods of textile printing herein, these discussions can be considered applicable to one another whether or not they are explicitly discussed in the context of that example. Thus, for example, when discussing an organic co-solvent related to the ink composition, such disclosure is also relevant to and directly supported in the context of the methods of textile printing, and vice versa. It is also understood that terms used herein will take on their ordinary meaning in the relevant technical field unless specified otherwise. In some instances, there are terms defined more specifically throughout the specification or included at the end of the present specification, and thus, these terms have a meaning as described herein.

### Ink Compositions

The ink compositions described herein can be particularly useful for textile printing. Many types of polymeric binders do not provide good durability when used in ink for printing on textiles. On the other hand, some polymeric binders may provide good durability but may not be jettable using inkjet printing architecture. For example, some polymeric binders can form particles or agglomerates that are too large to jet through an inkjet nozzle, and the polymeric binders can increase the viscosity of the ink and make the ink difficult to jet. Therefore, it can be difficult to formulate ink with polymeric binders that can provide good durability on textile media while also having good jettability. The ink compositions described herein include a polyurethane binder made from certain monomers, including graft diols that form specific side chains in the polyurethane polymer. The polyurethane binder can provide good durability when the ink compositions are printed on textile media, and the ink compositions can also have good jettability properties. In some examples, the ink compositions can be printed in conjunction with a crosslinker composition that can crosslink the polyurethane binder. This can further increase the durability of the printed ink. In certain examples, the ink compositions described herein can be used in direct-to-garment (DTG) and direct-to-fabric (DTF) printing processes.

The durability and jettability properties of the polyurethane binder can be due to the selection of monomers used to form the polyurethane binder. In some examples, the polyurethane binder can include polymerized pre-polymer segments. The pre-polymer segments can include polymerized monomers, including a diisocyanate, a graft diol, a polymeric diol, and an acid-containing diol. As explained above, the graft diol can have a specific structure including a thioglycerol molecule that has a polymer sidechain replacing a hydrogen atom of the sulfur atom of the thioglycerol molecule. The sidechain can include polymerized monomers such as an acrylate ester, a methacrylate ester, a styrene, or a combination thereof. The pre-polymer segments can be connected together by chain extenders. The chain extenders can include a polymerized sulfonate-containing diamine. The two amino groups in the sulfonate-containing diamine can react with isocyanate groups at the ends of the pre-polymer segments to connect the pre-polymer segments together.

As used herein, “polymerized” is used with respect to monomers or segments of polymers to describe the monomers or segments of polymers in their polymerized state, e.g., after the monomers have bonded together to form a polymer chain. The names of monomers in their original state may be used even though it is understood that the monomers change in certain ways during polymerizing. For example, “polymerized diisocyanate and diol” can refer to a polymer chain formed by polymerizing a diisocyanate and a diol, even though the diisocyanate and diol do not actually exist as separate molecules in the polymer. In the case of polymerized diisocyanates and diols, a hydrogen atom of the hydroxyl group of the diol is replaced by a bond between the oxygen atom of the hydroxyl group and the carbon atom of the isocyanate group of the diisocyanate. Thus, the diol is no longer a diol, but has become a portion of a polymer chain. However, “polymerized diol” may still be used to refer to this portion of the polymer chain for the sake of convenience. The portions of the polymer chain formed from diisocyanates or diols can also be referred to as “diisocyanate units” and “diol units” for convenience. Similarly, pre-polymer segments can be described as being polymerized because the pre-polymer segments can react with chain extenders to form longer polymer chains. After formation of the longer polymer chain, the pre-polymer segment and the chain extender compounds no longer exist as independent molecules. However, these can be referred to as “polymerized pre-polymer segments” and “polymerized chain extenders” for convenience.

The polyurethane binder can be formed by the following process. A pre-polymer segment can be formed by the reaction of a diisocyanate, a graft diol, a polymeric diol, and an acid-containing diol. In this reaction, the isocyanate groups of the diisocyanate can react with hydroxyl groups of the diols to link the monomers together. More specifically, a hydrogen atom from a hydroxyl group of the diol is replaced by a bond between the oxygen atom of the hydroxyl group and the carbon atom of an isocyanate group of the diisocyanate. This results in a “urethane linkage” joining together the diisocyanate and the diol. Thus, the pre-polymer segment can include alternating diisocyanate and diol units. In some examples, these monomers can be mixed together simultaneously, and this can result in random polymerization. Therefore, the graft diol, polymeric diol, and acid-containing diol can be randomly distributed along the pre-polymer segment between diisocyanate units. In some examples, an excess of the diisocyanate can be added to this reaction so that the product of the reaction can be pre-polymer segments that terminate is diisocyanate units at either end. Thus, the pre-polymer segments can have an unreacted isocyanate group at both ends that are available to react with additional monomers.

After forming the pre-polymer segments, a chain extender can be added. As mentioned above, the chain extender can include a sulfonate-containing diamine. The sulfonate-containing diamine can include two amino groups that can react with the unreacted isocyanate groups at the ends of pre-polymer segments. Thus, a single sulfonate-containing diamine molecule can react with isocyanate groups on two different pre-polymer segments to link the pre-polymer segments together. The sulfonate group of the sulfonate-containing diamine can help make the polyurethane polymer more water-dispersible.

In some examples, the diisocyanate, diols, and chain extenders described above can react in the presence of an organic solvent. After the polyurethane chain is complete, water can be added, and the organic solvent can be removed to form an aqueous dispersion of the polyurethane binder. In further examples, an excess of diisocyanate can be used when forming the polyurethane chains so that some unreacted isocyanate groups remain in the polyurethane binder dispersion. In certain examples, the polyurethane binder dispersion can have a D50 particle size from about 10 nm to about 400 nm.

In certain examples, the diisocyanate polymerized in the pre-polymer segment can be selected from the following diisocyanates:

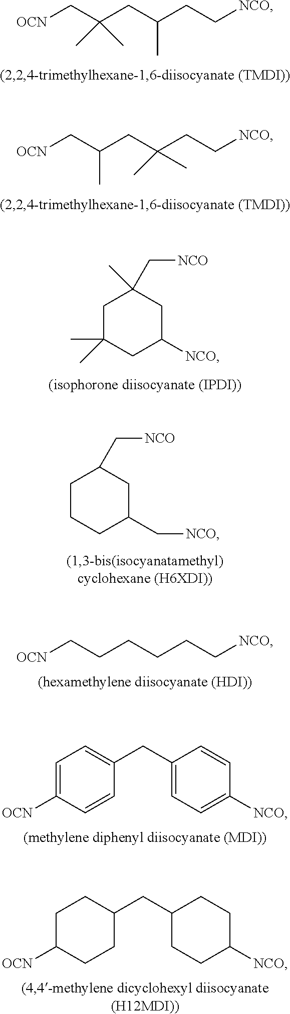

or a combination thereof.

The diisocyanate can be reacted with multiple different diols, including a graft diol, a polymeric diol, and an acid-containing diol. The graft diol can be a molecule that has two hydroxyl groups close together at one end of the molecule, with a polymeric sidechain at the other end of the molecule. The two hydroxyl groups can react with isocyanate groups of the diisocyanate when the graft diol polymerized to form the pre-polymer segment. Thus, the polymeric sidechain that was a part of the graft diol is “grafted” onto the pre-polymer segment. In some examples, the graft diol can be a thioglycerol molecule in which a polymer sidechain is attached to the sulfur atom, replacing a hydrogen that would be present on a normal thioglycerol molecule.

The polymer sidechain of the graft diol can be a polymer formed from a single monomer, or a random copolymer of multiple monomers. In various examples, the monomers in the sidechain can include an acrylate ester, a methacrylate ester, a styrene, or a combination thereof. As used herein, “an acrylate ester” can be an acrylate ester of any organic group. In some examples, the organic group can be an alkyl or cycloalkyl group. Similarly, the methacrylate ester can be an ester of any organic group such as alkyl or cycloalkyl groups. Additionally, “a styrene” can refer to the specific compound styrene, or to a compound having the structure of styrene substituted with an organic group or multiple organic groups. Again, the organic groups can include alkyl groups and cycloalkyl groups.

In certain examples, the graft diol can includes structure (I):

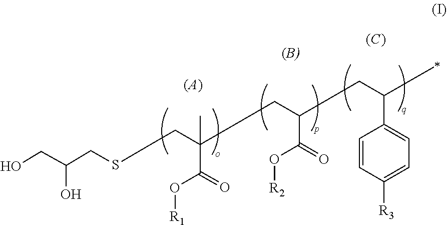

where R₁ is C1-C12 alkyl or C6-C16 cycloalkyl, R₂ is C1-C12 alkyl or C6-C16 cycloalkyl, and R₃ is a H, C1-C12 alkyl or C6-C16 cycloalkyl. The monomers identified as (A), (B), and (C) can be polymerized randomly, to form a random copolymer sidechain. In various examples, the monomers (A), (B), and (C) can all be present or one or two of the monomers can be absent. The numbers of the monomers in the sidechain are represent by o, p, and q, and can independently be 0 to 200, provided that o+p+q is from 5 to 200. Because the monomers can be randomly polymerized, the monomers can be ordered randomly along the sidechain. Therefore, the molecule shown in structure (I) is not limited to block copolymers that have a block of monomer (A), followed by a block of monomer (B), followed by a block of monomer (C). Instead, these monomers can be arranged in any order, such as in a random copolymer. Furthermore, the sidechain can be random copolymer of monomers (A) and (B) without (C), or a random copolymer of (A) and (C) without (B), or a random copolymer of (B) and (C) without (A). In further examples, the sidechain can be a homopolymer of monomer (A) alone, (B) alone, or (C) alone. In still further examples, multiple monomers matching the structures of (A), (B), and/or (C) can be used together. Thus, any number of different monomers matching these structures can be polymerized together to form the sidechain of the graft diol.

In certain examples, the graft diol can have a sidechain formed by polymerizing a methacrylate ester monomer and an acrylate ester monomer. In one example, the sidechain can be a random copolymer of methyl methacrylate and 2-ethylhexyl acrylate. In other examples, the sidechain can by a random copolymer of a methacrylate ester monomer, an acrylate ester monomer, and a styrene monomer. In a specific example, the sidechain can be a copolymer of methyl methacrylate, 2-ethylhexyl acrylate, and styrene. In various examples, the methacrylate ester monomer, acrylate ester monomer, and styrene monomer can be added in varying relative amounts. Any ratio of these monomers can be used depending on the desired composition of the sidechain. In some examples, the molar ratio of methyl methacrylate to 2-ethylhexyl acrylate can be from 10:90 to 90:10. In certain examples, equal or roughly equal molar amounts of the monomers can be used. Accordingly, in some examples the sidechain can include methyl methacrylate and 2-ethylhexyl acrylate in a 1:1 molar ratio. In further examples, the sidechain can include methyl methacrylate and 2-ethylhexyl acrylate in a 2:1 molar ratio, a 3:1 molar ratio, a 1:2 molar ratio, or a 1:3 molar ratio. In other examples, the sidechain can include methyl methacrylate, 2-ethylhexyl acrylate, and styrene in any desired molar ratio. In certain examples, the ratio of methyl methacrylate to 2-ethylhexyl acrylate to styrene can be a 1:1:1 molar ratio. In further examples, the sidechain can include methyl methacrylate, 2-ethylhexyl acrylate, and styrene in a 2:1:1 molar ratio, a 3:1:1 molar ratio, a 2:1:2 molar ratio, a 3:1:3 molar ratio, or other ratios. In various examples, the relative amounts of monomers in the sidechain can be adjusted to change the glass transition temperature of the graft diol. The glass transition temperature of graft diol can, in turn, affect the glass transition temperature of the final polyurethane binder. In further examples, the graft diol can have a weight average molecular weight from 500 Mw to 15,000 Mw. In other examples, the graft diol can have a weight average molecular weight from 1,000 Mw to 10,000 Mw or from 2,000 Mw to 8,000 Mw. In still further examples, the graft diol can have a weight average molecular weight from 500 Mw to 5,000 Mw, or from 5,000 Mw to 10,000 Mw, or from 10,000 Mw to 15,000 Mw.

The graft diol can be made by polymerizing thioglycerol with the monomers described above. In some examples, the thioglycerol and monomers can be mixed in the presence of an organic solvent and an initiator. Non-limiting examples of initiators that can be used include azoisobutyronitrile (AIBN), tert-amyl peroxybenzoate, 4,4-azobis(4-cyanovaleric acid), 1,1′-azobis(cyclohexanecarbonitrile), 2,2′-azobisisobutyronitrile (AlBN), benzoyl peroxide, 2,2-bis(tert-butylperoxy)butane, 1,1-bis(tert-butylperoxy)cyclohexane, 2,5-bis(tert-butylperoxy)-2,5-dimethylhexane, 2,5-bis(tert-Butylperoxy)-2,5-dimethyl-3-hexyne, bis(1-(tert-butylperoxy)-1-methylethyl)benzene, 1,1-bis(tert-butylperoxy)-3,3,5-(dibutyl phthalate)trimethylcyclohexane, tert-butyl hydroperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2,4-pentanedione peroxide, peracetic acid, and potassium persulfate. In some examples, the polymerization reaction can be allowed to proceed until a sidechain of a desired length is formed, and then the polymerization can be terminated. In certain examples, the polymerization reaction can be terminated by adding an alcohol to the reaction mixture.

As mentioned above, the polyurethane binder can also include polymerized polymeric diols that are a part of the pre-polymer segments. In some examples, the polymeric diols can have a polymer chain with hydroxyl groups at or near the ends of the polymer chain. For example, a first terminal hydroxyl group can be at a first end of the polymer diol and a second terminal hydroxyl group can be at a second end of the polymer diol. Therefore, the polymeric diol can be different from the graft diol, because the graft diol can include two hydroxyl groups that are close together at one end of the graft diol molecule, with a polymer sidechain at the other end of the graft diol molecule. Because of this difference in structure, the polymer chain of the polymeric diol can be in line with the main polymer backbone of the polyurethane binder, whereas the sidechain of the graft diol can hang off the polymer backbone of the polyurethane as a sidechain.

Although in some examples the polymeric diol can have exactly two hydroxyl groups, in other examples the polymeric diol can have additional hydroxyl groups. Therefore, polymeric diols having two or more hydroxyl groups can be polymerized in the pre-polymer segments of the polyurethane binder. In some examples, the polymeric diol can include polyether diols, polyester diols, polycarbonate diols, or combinations thereof. Non-limiting examples of commercially available polymeric diols can include the following polyols available from Stepan Company (Illinois): STEPANOL® bc-180, STEPANOL® PC-1011-45, STEPANOL® PC-1011-55, STEPANOL® PC-1011P-110, STEPANOL® PC-1011P-210, STEPANOL® PC-1015-55, STEPANOL® PC-1015P-120, STEPANOL® PC-1017P-55, STEPANOL® PC-101P-55, STEPANOL® PC-102-140, STEPANOL® PC-1021P-70, STEPANOL® PC-102-56, STEPANOL® PC-1028-115, STEPANOL® PC-1028P-210, STEPANOL® PC-1035-55, STEPANOL® PC-1040-55, STEPANOL® PC-1040P-55, STEPANOL® PC-105-10, STEPANOL® PC-105P-110, STEPANOL® PC-105P-30, STEPANOL® PC-107-110, STEPANOL® PC-107P-55, STEPANOL® PC-2011-225, STEPANOL® PC-2011-45, STEPANOL® PC-201-165, STEPANOL® PC-2019-35, STEPANOL® PC-2019-55, STEPANOL® PC-201P-110, STEPANOL® PC-205P-160, STEPANOL® PC-205P-20, STEPANOL® PC-205P-30, STEPANOL® PC-205P-56, STEPANOL® PC-207-125, STEPANOL® PC-2072P-30, STEPANOL® PC-5000P-30, STEPANOL® PC-5010P-35, STEPANOL® PC-5020-130, STEPANOL® PC-5020-160, STEPANOL® PC-5030-270, STEPANOL® PC-5040-167, STEPANOL® PC-5050P-60, STEPANOL® PC-5070P-56, STEPANOL® PC-5080-215, STEPANOL® PC-5080-285, STEPANOL® PC-5100P-56, STEPANOL® PC-5110-58, STEPANOL® PC-5120P-20, STEPANOL® PC-5130-160, STEPANOL® PD-195, STEPANOL® PD-320, STEPANOL® PD-56, STEPANOL® PDC-279, STEPANOL® PDP-70, STEPANOL® PH-56, and STEPANOL® PHN-56. Additional examples of polymeric diols can include polyols available from Kuraray America, Inc. (USA), including KURARAY™ C-590, KURARAY™ C-1090, KURARAY™ C-2090, and KURARAY™ 0-3090.

The pre-polymer segments can also include a polymerized acid-containing diol. The acid-containing diol can include a carboxylic acid group to help make the polyurethane binder more water-dispersible. In some examples, the acid-containing diol can be 2,2-bis(hydroxymethyl) propionic acid (DMPA) or 2,2-bis(hydroxymethyl) butyric acid (DMBA).

In some examples, the diisocyanate and the various diols can react together to form pre-polymer segments having isocyanate groups at one or both ends of the pre-polymer segments. In certain examples, the pre-polymer segments can be formed with a NCO/OH ratio from about 1 to about 10. In further examples, the NCO/OH ratio can be from about 1.2 to about 10 or from about 2 to about 3. As used herein, “NCO/OH ratio” refers to the mole ratio of NCO groups to OH groups in the monomers that react to form the pre-polymer segment.

The graft diol, polymeric diol, and acid-containing diol can be included at varying relative amounts. The some examples, the graft diol, polymeric diol, and acid-containing diol can be included in the pre-polymer segment at equivalent or roughly equivalent molar amounts, i.e., at a molar ratio of 1:1:1. In other examples, the pre-polymer segments can be polymerized from a mixture including 50 mol % to 90 mol % diisocyanate, 0.1 mol % to 50 mol % of the graft diol, 0.1 mol % to 50 mol % of the polymeric diol, and 0.1 mol % to 50 mol % of the acid-containing diol. In further examples, the pre-polymer segments can be polymerized from a mixture that includes 0.1 wt % to 90 wt % of the graft diol, 0.1 wt % to 90 wt % of the polymeric diol, and 0.1 wt % to 90 wt % of the acid-containing diol, and 0.1 wt % to 90 wt % of the diisocyanate. In still further examples, the pre-polymer segment can be polymerized from a mixture that includes 10 wt % to 35 wt % diisocyanate, 45 wt % to 70 wt % of the graft diol, 5 wt % to 20 wt % of the polymeric diol, and 3 wt % to 15 wt % of the acid-containing diol.

The pre-polymer segments can be formed by polymerizing the diisocyanate, graft diol, polymeric diol, and acid-containing diol described above. In some examples, the polymerization can be accomplished by mixing the monomers in the presence of an organic solvent and an initiator. In certain examples, the initiator can be dibutyl tin dilaurate (DBTDL). After polymerizing the pre-polymer segments, the pre-polymer segments can be linked together by adding a chain extender. The chain extender can include two reactive groups that can react with isocyanate groups at the ends of the pre-polymer segments.

As mentioned above, in some examples the chain extender can include a sulfonate-containing diamine. The sulfonate-containing diamine can have two amino groups that react with isocyanate groups at the ends of the pre-polymer segments. The sulfonate group can be an anionic group that can help make the polyurethane binder more water dispersible. In certain examples, the sulfonate-containing diamine can be 2-((2-Aminoethyl)amino)ethanesulfonate or a salt thereof. In one example, the sulfonate-containing diamine can include A-95™ available from Evonik (Germany).

In further examples, polyurethane binder can have an acid number from 10 mg KOH/g to 100 mg KOH/g. In other examples, the polyurethane binder can have an acid number from 15 mg KOH/g to 60 mg KOH/g or from 20 mg KOH/g to 40 mg KOH/g. The acid number can be adjusted by varying the relative amount of acid-containing diol used to form the polyurethane binder.

The polyurethane binder can be formed into a dispersion having polyurethane particles dispersed in an aqueous vehicle. As mentioned above, the polyurethane binder can be polymerized by mixing monomers in an organic solvent. After the polymerization, water can be added and/or organic solvent can be removed to form an aqueous dispersion of the polyurethane binder. In some examples, the polyurethane binder dispersion can have a D50 particle size from 10 nm to 400 nm. In other examples, the D50 particle size can be from 15 nm to 100 nm, or from 20 nm to 50 nm.

The polyurethane binder dispersion can be included in the ink composition in any amount that does not interfere with the jettability of the ink composition. In some examples, the polyurethane binder can be present in an amount from about 0.1 wt % to about 30 wt % with respect to the total weight of the ink composition. In further examples, the polyurethane binder can be present in an amount from about 0.1 wt % to about 15 wt %, or from about 0.5 wt % to about 10 wt %, or form about 0.6 wt % to 5 wt %, with respect to the total weight of the ink composition.

As mentioned above, the ink compositions can include water, an organic co-solvent, and a colorant in addition to the polyurethane binder. In some examples, the colorant can include a pigment. In some examples, pigment can be included in an amount from about 0.5 wt % to about 15 wt %, or from about 1 wt % to about 10 wt %, or from about 5 wt % to about 10 wt %, based on the total weight of the ink composition.

The pigment can be any of a number of pigments of any of a number of colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., PY74 and PY155. Other examples of pigments include the following, which are available from BASF Corp.: PALIOGEN® Orange, HELIOGEN® Blue L 6901F, HELIOGEN® Blue NBD 7010, HELIOGEN® Blue K 7090, HELIOGEN® Blue L 7101F, PALIOGEN® Blue L 6470, HELIOGEN® Green K 8683, HELIOGEN® Green L 9140, CHROMOPHTAL® Yellow 3G, CHROMOPHTAL® Yellow GR, CHROMOPHTAL® Yellow 8G, IGRAZIN® Yellow 5GT, and IGRALITE® Rubine 4BL. The following pigments are available from Degussa Corp.: Color Black FWI, Color Black FW2, Color Black FW2V, Color Black 18, Color Black, FW200, Color Black 5150, Color Black S160, and Color Black 5170. The following black pigments are available from Cabot Corp.: REGAL® 400R, REGAL® 330R, REGAL® 660R, MOGUL® L, BLACK PEARLS® L, MONARCH® 1400, MONARCH® 1300, MONARCH® 1100, MONARCH® 1000, MONARCH® 900, MONARCH® 880, MONARCH® 800, and MONARCH® 700. The following pigments are available from Orion Engineered Carbons GMBH: PRINTEX® U, PRINTEX® V, PRINTEX® 140U, PRINTEX® 140V, PRINTEX® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: TI-PURE® R-101. The following pigments are available from Heubach: MONASTRAL® Magenta, MONASTRAL® Scarlet, MONASTRAL® Violet R, MONASTRAL® Red B, and MONASTRAL® Violet Maroon B. The following pigments are available from Clariant: DALAMAR® Yellow YT-858-D, Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM® Yellow HR, NOVOPERM® Yellow FGL, Hansa Brilliant Yellow 10GX, Permanent Yellow G3R-01, HOSTAPERM® Yellow H4G, HOSTAPERM® Yellow H3G, HOSTAPERM® Orange GR, HOSTAPERM® Scarlet GO, and Permanent Rubine F6B. The following pigments are available from Sun Chemical: QUINDO® Magenta, INDOFAST® Brilliant Scarlet, QUINDO® Red R6700, QUINDO® Red R6713, INDOFAST® Violet, L74-1357 Yellow, L75-1331 Yellow, L75-2577 Yellow, and LHD9303 Black. The following pigments are available from Birla Carbon: RAVEN® 7000, RAVEN® 5750, RAVEN® 5250, RAVEN® 5000 Ultra® II, RAVEN® 2000, RAVEN® 1500, RAVEN® 1250, RAVEN® 1200, RAVEN® 1190 Ultra®. RAVEN® 1170, RAVEN® 1255, RAVEN® 1080, and RAVEN® 1060. The following pigments are available from Mitsubishi Chemical Corp.: No. 25, No. 33, No. 40, No. 47, No. 52, No. 900, No. 2300, MCF-88, MA600, MA7, MA8, and MA100. The colorant may be a white pigment, such as titanium dioxide, or other inorganic pigments such as zinc oxide and iron oxide.

Specific other examples of a cyan color pigment may include C.I. Pigment Blue −1, −2, −3, −15, −15:1, −15:2, −15:3, −15:4, −16, −22, and −60; magenta color pigment may include C.I. Pigment Red −5, −7, −12, −48, −48:1, −57, −112, −122, −123, −146, −168, −177, −184, −202, and C.I. Pigment Violet −19; yellow pigment may include C.I. Pigment Yellow −1, −2, −3, −12, −13, −14, −16, −17, −73, −74, −75, −83, −93, −95, −97, −98, −114, −128, −129, −138, −151, −154, and −180. Black pigment may include carbon black pigment or organic black pigment such as aniline black, e.g., C.I. Pigment Black 1. While several examples have been given herein, it is to be understood that any other pigment can be used that is useful in color modification, or dye may even be used in addition to the pigment.

Furthermore, pigments and dispersants are described separately herein, but there are pigments that are commercially available which include both the pigment and a dispersant suitable for ink composition formulation. Specific examples of pigment dispersions that can be used, which include both pigment solids and dispersant are provided by example, as follows: HPC-K048 carbon black dispersion from DIC Corporation (Japan), HSKBPG-11-CF carbon black dispersion from Dom Pedro (USA), HPC-C070 cyan pigment dispersion from DIC, CABOJET® 250C cyan pigment dispersion from Cabot Corporation (USA), 17-SE-126 cyan pigment dispersion from Dom Pedro, HPF-M046 magenta pigment dispersion from DIC, CABOJET® 265M magenta pigment dispersion from Cabot, HPJ-Y001 yellow pigment dispersion from DIC, 16-SE-96 yellow pigment dispersion from Dom Pedro, or EMACOL™ SF Yellow AE2060F yellow pigment dispersion from Sanyo (Japan).

Thus, the pigment(s) can be dispersed by a dispersant that is adsorbed or ionically attracted to a surface of the pigment, or can be covalently attached to a surface of the pigment as a self-dispersed pigment. In one example, the dispersant can be an acrylic dispersant, such as a styrene (meth)acrylate dispersant, or other dispersant suitable for keeping the pigment suspended in the liquid vehicle. In one example, the styrene (meth)acrylate dispersant can be used, as it can promote π-stacking between the aromatic ring of the dispersant and various types of pigments. In one example, the styrene (meth)acrylate dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or about 17,000 Mw. Regarding the acid number, the styrene (meth)acrylate dispersant can have an acid number from 100 mg KOH/g to 350 mg KOH/g, from 120 mg KOH/g to 350 mg KOH/g, from 150 mg KOH/g to 300 mg KOH/g, from 180 mg KOH/g to 250 mg KOH/g, or about 201 mg KOH/g to about 220 mg KOH/g, for example. Example commercially available styrene-acrylic dispersants can include JONCRYL® 671, JONCRYL® 71, JONCRYL® 96, JONCRYL® 680, JONCRYL® 683, JONCRYL® 678, JONCRYL® 690, JONCRYL®296, JONCRYL® 671, JONCRYL® 696 or JONCRYL® ECO 675 (all available from BASF Corp., Germany).

The term “(meth)acrylic” refers to monomers, copolymerized monomers, etc., that can either be acrylate or methacrylate (or a combination of both), or acrylic acid or methacrylic acid (or a combination of both), as the acid or salt/ester form can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylic should not be read so rigidly as to not consider relative pH levels, ester chemistry, and other general organic chemistry concepts.

The ink compositions of the present disclosure can be formulated to include a liquid vehicle, which can include the water content, e.g., 30 wt % to 99 wt %, 50 wt % to 95 wt %, 60 wt % to 90 wt % or from 70 wt % to 90 wt %, as well as organic co-solvent, e.g., from 1 wt % to 40 wt %, from 4 wt % to 30 wt %, from 4 wt % to 20 wt %, or from 5 wt % to 15 wt %. Other liquid vehicle components can also be included, such as surfactant, antibacterial agent, other colorant, etc. However, as part of the ink composition used in the systems and methods described herein, the pigment, dispersant, and polyurethane binder can be included or carried by the liquid vehicle components. Suitable pH ranges for the ink composition can be from pH 6 to pH 10, from pH 7 to pH 10, from pH 7.5 to pH 10, from pH 8 to pH 10, 6 to pH 9, from pH 7 to pH 9, from pH 7.5 to pH 9, etc.

In further detail regarding the liquid vehicle, the organic co-solvent(s) can be present and can include any co-solvent or combination of co-solvents that is compatible with the pigment, dispersant, and polyurethane binder. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The liquid vehicle can also include surfactant and/or emulsifier. The surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a SURFYNOL® surfactant, e.g., SURFYNOL® 440 (from Evonik, Germany), or a TERGITOL™ surfactant, e.g., TERGITOL™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., CRODAFOS® N3A (from Croda International PLC, United Kingdom). The surfactant or combinations of surfactants, if present, can be included in the ink composition at from about 0.01 wt % to about 5 wt % and, in some examples, can be present at from about 0.05 wt % to about 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, ACTICIDE®, e.g., ACTICIDE® B20 (Thor Specialties Inc.), NUOSEPT™ (Nudex, Inc.), UCARCIDE™ (Union carbide Corp.), VANCIDE® (R.T. Vanderbilt Co.), PROXEL™ (ICI America), and combinations thereof. Sequestering agents, such as EDTA (ethylene diamine tetra acetic acid) or trisodium salt of methylglycinediacetic acid, may be included to eliminate the deleterious effects of heavy metal impurities, and buffer solutions may be used to control the pH of the ink. Viscosity modifiers and buffers may also be present, as well as other additives to modify properties of the ink as desired.

### Textile Printing Systems

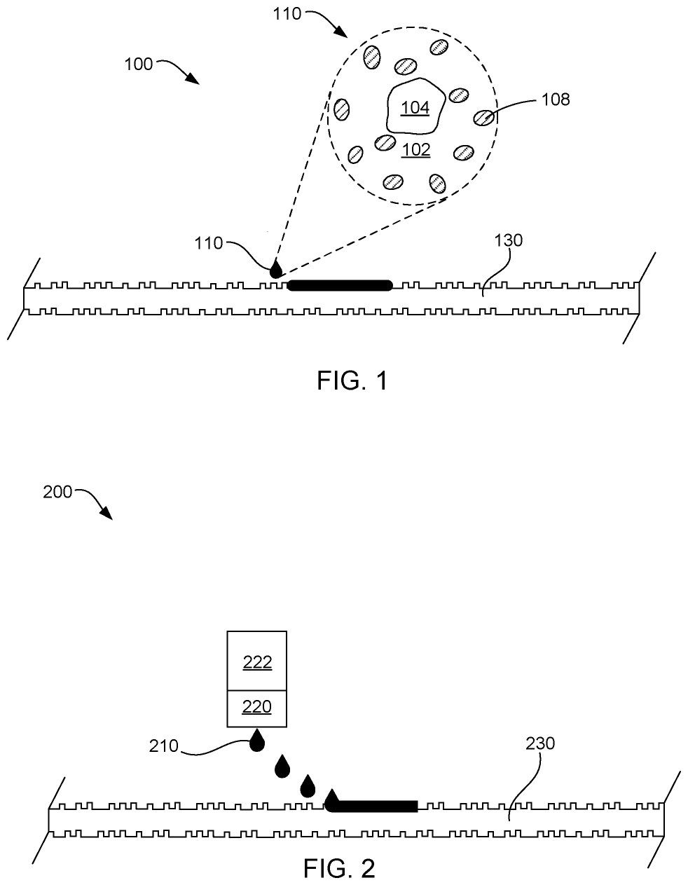

The ink compositions described herein can be used in textile printing systems. FIG. 1 shows an example textile printing system 100 which includes a fabric substrate 130 and an ink composition 110. The ink composition includes water, an organic co-solvent (shown collectively as liquid vehicle 102), pigment 104 as a colorant, and particles of the polyurethane binder 108 described above. The ink composition can also include any of the other ingredients described above. As explained above, the polyurethane binder can give the ink composition good durability when printed. The ink composition can be printed on various types of fabrics, such as cotton, nylon, silk, polyester, cotton/polyester blend, etc. The durability of the printed ink on the fabric can be tested by washing, for example by performing a washfastness test that includes five (5) standard washing machine cycles using warm water and a standard clothing detergent. Acceptable optical density retention and other color properties of the printed inks can be the result. Additionally, the ink compositions can also exhibit good stability over time as well as good thermal inkjet printhead performance such as high drop weight, high drop velocity, and good kogation.

The term “washfastness” can be defined as the optical density (OD) or delta E (ΔE) that is retained after five (5) standard washing machine cycles using warm water and a standard clothing detergent (e.g., TIDE® available from Proctor and Gamble, Cincinnati, Ohio, USA). By measuring OD and/or L*a*b* both before and after washing, ΔOD and ΔE value can be determined, which is a quantitative way of expressing the difference between the OD and/or L*a*b*prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE CIE.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. This can be referred to herein as the “ΔE 1994.” Then in 2000, the CIEDE standard was established to further resolve the perceptual non-uniformities by adding five corrections, namely i) hue rotation (R_{T}) to deal with the blue region at hue angles of about 275°), ii) compensation for neutral colors or the primed values in the L*C*h differences, iii) compensation for lightness (S_{L}), iv) compensation for chroma (S_{C}), and v) compensation for hue (SH). The 2000 modification can be referred to herein as “ΔE 2000.” In accordance with examples of the present disclosure, ΔE value can be determined using the CIE definition established in 1976, 1994, and 2000 to demonstrate washfastness. Further, a difference measurement has also been established, based on an L*C*h model was defined and called CMC I:c. This metric has two parameters: lightness (I) and chroma (c), allowing users to weigh the difference based on the ratio of I:c that is deemed appropriate for the application. Commonly used values include 2:1 for acceptability and 1:1 for threshold of imperceptibility. This difference metric is also reported in various examples of the present disclosure. This can be referred to as “ΔE CMC 2:1” or “ΔE CMC 1:1,” depending on the I and c values selected for measurement.

As shown in FIG. 2, a textile printing system 200 can print the ink compositions 210 on fabric substrates 230. For example, the ink compositions can be printed from an inkjet printhead 220 which includes an ejector, such as a thermal inkjet ejector, for example. The printhead is in fluid communication with a reservoir 222 that contains the ink composition.

These ink compositions can be suitable for printing on many types of textiles, but can be particularly acceptable on treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Treated fabrics can include a coating, for example, such as a coating including a cationic component such as calcium salt, magnesium salt, cationic polymer, etc. These types of substrates can provide acceptable optical density (OD) and/or washfastness properties.

In further detail regarding the fabric substrates, the fabric can include a substrate, and in some examples can be treated, such as with a coating that includes a calcium salt, a magnesium salt, a cationic polymer, or a combination of a calcium or magnesium salt and cationic polymer. Fabric substrates can include substrates that have fibers that may be natural and/or synthetic. The fabric substrate can include, for example, a textile, a cloth, a fabric material, fabric clothing, or other fabric product suitable for applying ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” does not include materials referred to as any kind of paper (even though paper can include multiple types of natural and synthetic fibers or mixtures of both types of fibers). Fabric substrates can include textiles in filament form, textiles in the form of fabric material, or textiles in the form of fabric that has been crafted into a finished article (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with a twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of two or more of these processes.

Regardless of the structure, in one example, the fabric substrate can include natural fibers, synthetic fibers, or a combination thereof. Examples of natural fibers can include, but are not limited to, wool, cotton, silk, linen, jute, flax, hemp, rayon fibers, thermoplastic aliphatic polymeric fibers derived from renewable resources (e.g. cornstarch, tapioca products, sugarcanes), or a combination thereof. In another example, the fabric substrate can include synthetic fibers. Examples of synthetic fibers can include polymeric fibers such as, polyvinyl chloride (PVC) fibers, PVC-free fibers made of polyester, polyamide, polyimide, polyacrylic, polypropylene, polyethylene, polyurethane, polystyrene, polyaramid (e.g., KEVLAR®) polytetrafluoroethylene (TEFLON®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the synthetic fiber can be a modified fiber from the above-listed polymers. The term “modified fiber” refers to one or both of the polymeric fiber and the fabric as a whole having undergone a chemical or physical process such as, but not limited to, a copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation. The term “PVC-free fibers” as used herein means that no polyvinyl chloride (PVC) polymer or vinyl chloride monomer units are in the fibers.

As previously mentioned, the fabric substrate can be a combination of fiber types, e.g. a combination of any natural fiber with another natural fiber, any natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber. The amount of the individual fiber types can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from about 10 gsm to about 500 gsm. In another example, the fabric substrate can have a basis weight ranging from about 50 gsm to about 400 gsm. In other examples, the fabric substrate can have a basis weight ranging from about 100 gsm to about 300 gsm, from about 75 gsm to about 250 gsm, from about 125 gsm to about 300 gsm, or from about 150 gsm to about 350 gsm.

In addition, the fabric substrate can contain additives including, but not limited to, colorant (e.g., pigments, dyes, and tints), antistatic agents, brightening agents, nucleating agents, antioxidants, UV stabilizers, fillers, and lubricants, for example. Alternatively, the fabric substrate may be pre-treated in a solution containing the substances listed above before applying other treatments or coating layers.

### Methods of Textile Printings

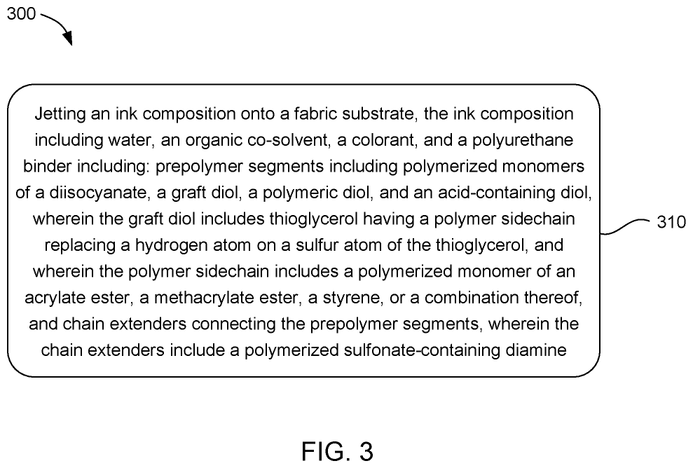

The ink compositions described herein and the textile printing systems described herein can also be used in methods of textile printing. FIG. 3 shows a flowchart of one example method 300 of textile printing. The method includes: jetting 310 an ink composition onto a fabric substrate, the ink composition including: water, an organic co-solvent, a colorant, and a polyurethane binder including: pre-polymer segments including polymerized monomers of a diisocyanate, a graft diol, a polymeric diol, and an acid-containing diol, wherein the graft diol includes thioglycerol having a polymer sidechain replacing a hydrogen atom on a sulfur atom of the thioglycerol, and wherein the polymer sidechain includes a polymerized monomer of an acrylate ester, a methacrylate ester, a styrene, or a combination thereof, and chain extenders connecting the pre-polymer segments, wherein the chain extenders include a polymerized sulfonate-containing diamine.

In some examples, a crosslinker composition can be applied onto the fabric substrate before jetting the ink composition. In other examples, the crosslinker composition can be applied after or concurrently with the ink composition. The crosslinker composition can include a crosslinker that is reactive with the polyurethane binder to crosslink the polyurethane binder. This can increase the durability of the ink printed on the fabric substrate. In some examples, the crosslinker can include blocked isocyanates, polycarbondiimides or polymeric azetidinium salts. In certain examples, the crosslinker can be a polyimine based azetidinium salt such as POLYCUP™ 7360A from Solenis (USA), which has the following structure:

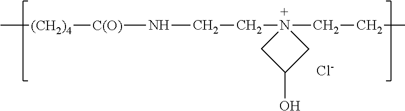

The crosslinker composition can also include a liquid vehicle with any of the liquid vehicle components described above with respect to the inks.

In some examples, a fixer composition may also be used in addition to the crosslinker composition, or instead of the crosslinker composition. As mentioned, there are also examples that do not use either a crosslinker composition or a fixer composition. Fixer compositions can include metal salts that can help fix pigments on the fabric substrate. Non-limiting examples of metal salt fixers can include salts of metal cations such as Ca²⁺, Cu²⁺, Ni²⁺, Mg²⁺, Zn²⁺ Ba²⁺, Al³⁺, Fe³⁺ or Cr³⁺ with anions such as Cl⁻, I⁻, Br⁻, NO₃⁻ or RCOO⁻ (where R is H or any hydrocarbon chain). In some examples, fixer compositions can also include liquid vehicle components such as those described above with respect to the ink compositions.

In further examples, the ink compositions described herein can be cured after printing by heating the printed fabric to a curing temperature for a period of time. Therefore, in some examples the method of textile printing can include curing the ink composition after printing on the fabric substrate by heating the fabric substrate. In certain examples, the fabric substrate can be heated to a curing temperature from 50° C. to 180° C. In further examples, the curing temperature can be from 60° C. to 150° C. or from 70° C. to 130° C. The fabric substrate can be heated at this temperature for a curing time. In some examples, the curing time can be from 30 seconds to 30 minutes. In further examples, the curing time can be from 1 minute to 10 minutes, from 1 minute to 5 minutes, or from 1 minute to 3 minutes.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable based on experience and the associated description herein.

The term “acid value” or “acid number” refers to the mass of potassium hydroxide (KOH) in milligrams that can be used to neutralize one gram of substance (mg KOH/g), such as the polyurethane binders disclosed herein. This value can be determined, in one example, by dissolving or dispersing a known quantity of a material in organic solvent and then titrating with a solution of potassium hydroxide (KOH) of known concentration for measurement.

“D50” particle size is defined as the particle size at which about half of the particles are larger than the D50 particle size and about half of the other particles are smaller than the D50 particle size (by weight based on the particle content). As used herein, particle size with respect to the polyurethane binder particles can be based on volume of the particle size normalized to a spherical shape for diameter measurement, for example. Particle size can be collected using a Malvern ZETASIZER™ from Malvern Panalytical (United Kingdom), for example. Likewise, the “D95” is defined as the particle size at which about 5 wt % of the particles are larger than the D95 particle size and about 95 wt % of the remaining particles are smaller than the D95 particle size. Particle size information can also be determined and/or verified using a scanning electron microscope (SEM), or can be measured using a particle analyzer such as the MASTERSIZER™ 3000 available from Malvern Panalytical, for example. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, a plurality of items, structural elements, compositional elements, and/or materials may be presented in a common list for convenience. However, these lists should be construed as though the members of the list are individually identified as separate and unique members. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if the numerical values and sub-ranges are explicitly recited. For example, a weight ratio range of about 1 wt % to about 20 wt % should be interpreted to include the explicitly recited limits of about 1 wt % and about 20 wt %, and also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Synthesis of Graft Diol A

Graft diol A was made by polymerizing thioglycerol, methyl methacrylate, and 2-ethylhexyl acrylate in the presence of an initiator and a solvent under heating. 80 grams of thioglycerol, 16 grams of azoisobutyronitrile (AIBN), 1200 grams of methyl methacrylate (MMA), 400 grams of 2-ethylhexylacrylate (EHA), and 1000 grams of Acetone were mixed in a beaker until completely dissolved. The solution was transferred to a reagent bottle with a narrow opening and blanketed with nitrogen. A 3-liter 4-neck RB flask was immersed in a water bath. A mechanical stirrer, a condenser and nitrogen inlet were attached. Water bath temperature was raised to 75° C. 300 ml of monomer solution was pumped to the reactor and polymerized for 15 minutes. The rest of the monomer solution was pumped to the reactor over 120 minutes. Polymerization was continued overnight at 75° C. A small sample of polyol was analyzed by GC and LC to ensure the complete conversion of monomers, thioglycerol and AIBN. The reaction solution was cooled to 40° C. and bottled for use. The solid content was 73 wt % and the weight average molecular weight was 3500 Mw.

### Example 2—Synthesis of Graft Diol B

Graft diol B was made by polymerizing thioglycerol, methyl methacrylate, 2-ethylhexyl acrylate, and styrene in the presence of an initiator and a solvent under heating. 80 grams of thioglycerol, 16 grams of AIBN, 800 grams of methyl methacrylate (MMA), 400 grams of 2-ethylhexylacrylate (EHA), 400 grams of styrene and 1000 grams of Acetone were mixed in a beaker until completely dissolved. The solution was transferred to a reagent bottle with a narrow opening and blanketed with nitrogen. A 3-liter 4-neck RB flask was immersed in a water bath. A mechanical stirrer, a condenser and nitrogen inlet were attached. Water bath temperature was raised to 75° C. 300 ml of monomer solution was pumped to the reactor and polymerized for 15 minutes. The rest of monomer solution was pumped to the reactor over 120 minutes. Polymerization was continued overnight at 75° C. A small sample of polyol was analyzed by GC and LC to ensure the complete conversion of monomers, thioglycerol and AIBN. The reaction solution was cooled to 40° C. and bottled for use. The solids content was 72 wt % and the weight average molecular weight was 3200 Mw.

### Example 3—Synthesis of Polyurethane Binder GPUD-1

11.099 grams of polycarbonate polyol (KURARAY™ C-590 from Kuraray America, Inc., USA, MW 500), graft diol A (69.537 g, 72.56 wt % in ethyl acetate), 26.506 grams of Isophorone diisocyanate (IPDI), and 5.414 grams of 2,2-bis(hydroxymethyl)propionic acid (DMPA) in 42 grams of acetone were mixed in a 500 mL 4-neck round bottom flask. A mechanical stirrer with glass rod and TEFLON® (E. I. du Pont de Nemours Company, Delaware) blade was attached. A condenser was attached. The flask was immersed in a constant temperature bath at 60° C. The system was kept under drying tube. 3 drops of DBTDL were added to initiate the polymerization. Polymerization was continued for 3 hours at 60° C. A 0.5-gram sample was withdrawn for wt % NCO titration to confirm the reaction. The measured NCO value was 3.09 wt %. Theoretical wt % NCO was 3.10 wt %. The polymerization temperature was reduced to 40° C. 13.051 grams of sulfonate-containing diamine (A-95™, Evonik, Germany, 50 wt % in water) and 3.390 grams of 50 wt % sodium hydroxide aqueous solution in 32.267 grams of deionized water are mixed in a beaker until A-95™ is completely dissolved. The A-95™ solution was added to the pre-polymer solution at 40° C. with vigorous stirring over 5 minutes. The solution became viscous and slight hazy. The mixture was stirred for 30 minutes at 40° C. Then 164.317 grams of deionized water was added to the polymer mixture in the 4-neck round bottom flask over 10 minutes with good agitation to form a polyurethane dispersion (PUD). The agitation was continued for 60 minutes at 40° C. The PUD was filtered through a 400 mesh stainless sieve. Acetone was removed with Rotorvap at 40° C. (add 2 drops (20 mg) BYK™-011 de-foaming agent, BYK, Germany). The final PUD was filtered through fiber glass filter paper. Particle size measured by Malvern ZETASIZER™ (Malvern Panalytical, United Kingdom) is 150.7 nm. The pH was 8.5. The solids content was 34.09 wt %. The acid number was 41.9 mg KOH/g.

### Example 4—Synthesis of Polyurethane Binder GPUD-2

11.260 grams of polycarbonate polyol (KURARAY™ C-590 from Kuraray America, Inc., USA, MW 500), graft diol A (70.548 g, 72.56 wt % in ethyl acetate), 25.438 grams of 2,2,4 (or 2, 4, 4)-trimethylhexane-1,6-diisocyanate (TMDI), and 5.492 grams of 2,2-bis(hydroxymethyl)propionic acid (DMPA) in 42 grams of acetone were mixed in a 500 mL 4-neck round bottom flask. A mechanical stirrer with glass rod and TEFLON® (E. I. du Pont de Nemours Company, Delaware) blade was attached. A condenser was attached. The flask was immersed in a constant temperature bath at 60° C. The system was kept under drying tube. 3 drops of DBTDL were added to initiate the polymerization. Polymerization was continued for 3 hours at 60° C. A 0.5-gram sample was withdrawn for wt % NCO titration to confirm the reaction. The measured NCO value was 3.12 wt %. Theoretical wt % NCO was 3.15 wt %. The polymerization temperature was reduced to 40° C. 13.240 grams of sulfonate-containing diamine (A-95™, Evonik, Germany, 50 wt % in water) and 3.440 grams of 50 wt % sodium hydroxide aqueous solution in 33.101 grams of deionized water are mixed in a beaker until A-95™ is completely dissolved. The A-95™ solution was added to the pre-polymer solution at 40° C. with vigorous stirring over 5 minutes. The solution became viscous and slight hazy. The mixture was stirred for 30 minutes at 40° C. Then 163.661 grams of deionized water was added to the polymer mixture in the 4-neck round bottom flask over 10 minutes with good agitation to form a polyurethane dispersion (PUD). The agitation was continued for 60 minutes at 40° C. The PUD was filtered through a 400 mesh stainless sieve. Acetone was removed with Rotorvap at 40° C. (add 2 drops (20 mg) BYK™-011 de-foaming agent, BYK, Germany). The final PUD was filtered through fiber glass filter paper. Particle size measured by Malvern ZETASIZER™ (Malvern Panalytical, United Kingdom) is 30.49 nm. The pH was 9.5. The solids content was 22.8 wt %. The acid number was 42.5 mg KOH/g.

### Example 5—Synthesis of Polyurethane Binder GPUD-3

11.483 grams of polycarbonate polyol (KURARAY™ C-590 from Kuraray America, Inc., USA, MW 500), graft diol A (71.944 g, 72.56 wt % in ethyl acetate), 23.962 grams of 1,3-bis(isocyanatomethyl)cyclohexane (H6XDI), and 5.601 grams of 2,2-bis(hydroxymethyl)propionic acid (DMPA) in 42 grams of acetone were mixed in a 500 mL 4-neck round bottom flask. A mechanical stirrer with glass rod and TEFLON® (E. I. du Pont de Nemours Company, Delaware) blade was attached. A condenser was attached. The flask was immersed in a constant temperature bath at 60° C. The system was kept under drying tube. 3 drops of DBTDL were added to initiate the polymerization. Polymerization was continued for 3 hours at 60° C. A 0.5-gram sample was withdrawn for wt % NCO titration to confirm the reaction. The measured NCO value was 3.19 wt %. Theoretical wt % NCO was 3.21 wt %. The polymerization temperature was reduced to 40° C. 13.502 grams of sulfonate-containing diamine (A-95™, Evonik, Germany, 50 wt % in water) and 3.508 grams of 50 wt % sodium hydroxide aqueous solution in 33.756 grams of deionized water are mixed in a beaker until A-95™ is completely dissolved. The A-95™ solution was added to the pre-polymer solution at 40° C. with vigorous stirring over 5 minutes. The solution became viscous and slight hazy. The mixture was stirred for 30 minutes at 40° C. Then 162.754 grams of deionized water was added to the polymer mixture in the 4-neck round bottom flask over 10 minutes with good agitation to form a polyurethane dispersion (PUD). The agitation was continued for 60 minutes at 40° C. The PUD was filtered through a 400 mesh stainless sieve. Acetone was removed with Rotorvap at 40° C. (add 2 drops (20 mg) BYK™-011 de-foaming agent, BYK, Germany). The final PUD was filtered through fiber glass filter paper. Particle size measured by Malvern ZETASIZER™ (Malvern Panalytical, United Kingdom) is 27.08 nm. The pH was 8.5. The solids content was 34.23 wt %. The acid number was 43.3 mg KOH/g.

### Example 6—Synthesis of Polyurethane Binder GPUD-4

11.483 grams of polycarbonate polyol (KURARAY™ C-590 from Kuraray America, Inc., USA, MW 500), graft diol A (74.331 g, 72.56 wt % in ethyl acetate), 21.439 grams of hexamethylene diisocyanate (HDI), and 5.601 grams of 2,2-bis(hydroxymethyl)propionic acid (DMPA) in 42 grams of acetone were mixed in a 500 mL 4-neck round bottom flask. A mechanical stirrer with glass rod and TEFLON® (E. I. du Pont de Nemours Company, Delaware) blade was attached. A condenser was attached. The flask was immersed in a constant temperature bath at 60° C. The system was kept under drying tube. 3 drops of DBTDL were added to initiate the polymerization. Polymerization was continued for 3 hours at 60° C. A 0.5-gram sample was withdrawn for wt % NCO titration to confirm the reaction. The measured NCO value was 3.31 wt %. Theoretical wt % NCO was 3.33 wt %. The polymerization temperature was reduced to 40° C. 13.950 grams of sulfonate-containing diamine (A-95™, Evonik, Germany, 50 wt % in water) and 3.624 grams of 50 wt % sodium hydroxide aqueous solution in 34.876 grams of deionized water are mixed in a beaker until A-95™ is completely dissolved. The A-95™ solution was added to the pre-polymer solution at 40° C. with vigorous stirring over 5 minutes. The solution became viscous and slight hazy. The mixture was stirred for 30 minutes at 40° C. Then 161.203 grams of deionized water was added to the polymer mixture in the 4-neck round bottom flask over 10 minutes with good agitation to form a polyurethane dispersion (PUD). The agitation was continued for 60 minutes at 40° C. The PUD was filtered through a 400 mesh stainless sieve. Acetone was removed with Rotorvap at 40° C. (add 2 drops (20 mg) BYK™-011 de-foaming agent, BYK, Germany). The final PUD was filtered through fiber glass filter paper. Particle size measured by Malvern ZETASIZER™ (Malvern Panalytical, United Kingdom) is 40.84 nm. The pH was 8.5. The solids content was 24 wt %. The acid number was 44.8 mg KOH/g.

### Example 7—Synthesis of Polyurethane Binder GPUD-5

11.099 grams of polycarbonate polyol (KURARAY™ C-590 from Kuraray America, Inc., USA, MW 500), graft diol A (69.537 g, 72.56 wt % in ethyl acetate), 13.086 grams of isophorone diisocyanate (IPDI), 15.445 grams of 4,4′-methylene dicyclohexyl diisocyanate (H12MDI), and 5.264 grams of 2,2-bis(hydroxymethyl)propionic acid (DMPA) in 42 grams of acetone were mixed in a 500 mL 4-neck round bottom flask. A mechanical stirrer with glass rod and TEFLON® (E. I. du Pont de Nemours Company, Delaware) blade was attached. A condenser was attached. The flask was immersed in a constant temperature bath at 60° C. The system was kept under drying tube. 3 drops of DBTDL were added to initiate the polymerization. Polymerization was continued for 3 hours at 60° C. A 0.5-gram sample was withdrawn for wt % NCO titration to confirm the reaction. The measured NCO value was 3.16 wt %. Theoretical wt % NCO was 3.17 wt %. The polymerization temperature was reduced to 40° C. 12.691 grams of sulfonate-containing diamine (A-95™, Evonik, Germany, 50 wt % in water) and 3.297 grams of 50 wt % sodium hydroxide aqueous solution in 31.728 grams of deionized water are mixed in a beaker until A-95™ is completely dissolved. The A-95™ solution was added to the pre-polymer solution at 40° C. with vigorous stirring over 5 minutes. The solution became viscous and slight hazy. The mixture was stirred for 30 minutes at 40° C. Then 165.563 grams of deionized water was added to the polymer mixture in the 4-neck round bottom flask over 10 minutes with good agitation to form a polyurethane dispersion (PUD). The agitation was continued for 60 minutes at 40° C. The PUD was filtered through a 400 mesh stainless sieve. Acetone was removed with Rotorvap at 40° C. (add 2 drops (20 mg) BYK™-011 de-foaming agent, BYK, Germany). The final PUD was filtered through fiber glass filter paper. Particle size measured by Malvern ZETASIZER™ (Malvern Panalytical, United Kingdom) is 160.5 nm. The pH was 9. The solids content was 31.82 wt %. The acid number was 40.7 mg KOH/g.

### Example 8—Synthesis of Polyurethane Binder GPUD-6

10.922 grams of polycarbonate polyol (KURARAY™ C-590 from Kuraray America, Inc., USA, MW 500), graft diol A (68.428 g, 72.56 wt % in ethyl acetate), 19.863 grams of isophorone diisocyanate (IPDI), 7.815 grams of 4,4′-methylene dicyclohexyl diisocyanate (H12MDI), and 5.327 grams of 2,2-bis(hydroxymethyl)propionic acid (DMPA) in 42 grams of acetone were mixed in a 500 mL 4-neck round bottom flask. A mechanical stirrer with glass rod and TEFLON® (E. I. du Pont de Nemours Company, Delaware) blade was attached. A condenser was attached. The flask was immersed in a constant temperature bath at 60° C. The system was kept under drying tube. 3 drops of DBTDL were added to initiate the polymerization. Polymerization was continued for 3 hours at 60° C. A 0.5-gram sample was withdrawn for wt % NCO titration to confirm the reaction. The measured NCO value was 3.20 wt %. Theoretical wt % NCO was 3.21 wt %. The polymerization temperature was reduced to 40° C. 12.843 grams of sulfonate-containing diamine (A-95™, Evonik, Germany, 50 wt % in water) and 3.336 grams of 50 wt % sodium hydroxide aqueous solution in 32.106 grams of deionized water are mixed in a beaker until A-95™ is completely dissolved. The A-95™ solution was added to the pre-polymer solution at 40° C. with vigorous stirring over 5 minutes. The solution became viscous and slight hazy. The mixture was stirred for 30 minutes at 40° C. Then 165.038 grams of deionized water was added to the polymer mixture in the 4-neck round bottom flask over 10 minutes with good agitation to form a polyurethane dispersion (PUD). The agitation was continued for 60 minutes at 40° C. The PUD was filtered through a 400 mesh stainless sieve. Acetone was removed with Rotorvap at 40° C. (add 2 drops (20 mg) BYK™-011 de-foaming agent, BYK, Germany). The final PUD was filtered through fiber glass filter paper. Particle size measured by Malvern ZETASIZER™ (Malvern Panalytical, United Kingdom) is 165.6 nm. The pH was 8.5. The solids content was 32.53 wt %. The acid number was 41.2 mg KOH/g.

### Example 9—Synthesis of Polyurethane Binder GPUD-7

19.980 grams of polycarbonate polyol (KURARAY™ C-1090 from Kuraray America, Inc., USA, MW 1000), graft diol A (62.590 g, 72.56 wt % in ethyl acetate), 23.858 grams of isophorone diisocyanate (IPDI), and 4.873 grams of 2,2-bis(hydroxymethyl)propionic acid (DMPA) in 42 grams of acetone were mixed in a 500 mL 4-neck round bottom flask. A mechanical stirrer with glass rod and TEFLON® (E. I. du Pont de Nemours Company, Delaware) blade was attached. A condenser was attached. The flask was immersed in a constant temperature bath at 60° C. The system was kept under drying tube. 3 drops of DBTDL were added to initiate the polymerization. Polymerization was continued for 3 hours at 60° C. A 0.5-gram sample was withdrawn for wt % NCO titration to confirm the reaction. The measured NCO value was 2.76 wt %. Theoretical wt % NCO was 2.77 wt %. The polymerization temperature was reduced to 40° C. 11.747 grams of sulfonate-containing diamine (A-95™, Evonik, Germany, 50 wt % in water) and 3.052 grams of 50 wt % sodium hydroxide aqueous solution in 29.367 grams of deionized water are mixed in a beaker until A-95™ is completely dissolved. The A-95™ solution was added to the pre-polymer solution at 40° C. with vigorous stirring over 5 minutes. The solution became viscous and slight hazy. The mixture was stirred for 30 minutes at 40° C. Then 168.831 grams of deionized water was added to the polymer mixture in the 4-neck round bottom flask over 10 minutes with good agitation to form a polyurethane dispersion (PUD). The agitation was continued for 60 minutes at 40° C. The PUD was filtered through a 400 mesh stainless sieve. Acetone was removed with Rotorvap at 40° C. (add 2 drops (20 mg) BYK™-011 de-foaming agent, BYK, Germany). The final PUD was filtered through fiber glass filter paper. Particle size measured by Malvern ZETASIZER™ (Malvern Panalytical, United Kingdom) is 56.78 nm. The pH was 7.5. The solids content was 34.34 wt %. The acid number was 37.7 mg KOH/g.

### Example 10—Synthesis of Polyurethane Binder GPUD-8

33.306 grams of polycarbonate polyol (KURARAY™ C-2090 from Kuraray America, Inc., USA, MW 2000), graft diol A (52.167 g, 72.56 wt % in ethyl acetate), 19.885 grams of isophorone diisocyanate (IPDI), and 4.061 grams of 2,2-bis(hydroxymethyl)propionic acid (DMPA) in 42 grams of acetone were mixed in a 500 mL 4-neck round bottom flask. A mechanical stirrer with glass rod and TEFLON® (E. I. du Pont de Nemours Company, Delaware) blade was attached. A condenser was attached. The flask was immersed in a constant temperature bath at 60° C. The system was kept under drying tube. 3 drops of DBTDL were added to initiate the polymerization. Polymerization was continued for 3 hours at 60° C. A 0.5-gram sample was withdrawn for wt % NCO titration to confirm the reaction. The measured NCO value was 2.28 wt %. Theoretical wt % NCO was 2.29 wt %. The polymerization temperature was reduced to 40° C. 9.791 grams of sulfonate-containing diamine (A-95™, Evonik, Germany, 50 wt % in water) and 2.543 grams of 50 wt % sodium hydroxide aqueous solution in 24.477 grams of deionized water are mixed in a beaker until A-95™ is completely dissolved. The A-95™ solution was added to the pre-polymer solution at 40° C. with vigorous stirring over 5 minutes. The solution became viscous and slight hazy. The mixture was stirred for 30 minutes at 40° C. Then 175.604 grams of deionized water was added to the polymer mixture in the 4-neck round bottom flask over 10 minutes with good agitation to form a polyurethane dispersion (PUD). The agitation was continued for 60 minutes at 40° C. The PUD was filtered through a 400 mesh stainless sieve. Acetone was removed with Rotorvap at 40° C. (add 2 drops (20 mg) BYK™-011 de-foaming agent, BYK, Germany). The final PUD was filtered through fiber glass filter paper. Particle size measured by Malvern ZETASIZER™ (Malvern Panalytical, United Kingdom) is 44.24 nm. The pH was 7. Solid content was 32.45 wt %. The acid number was 31.4 mg KOH/g.

### Example 11—Synthesis of Polyurethane Binder GPUD-9

42.287 grams of polycarbonate polyol (KURARAY™ C-3090 from Kuraray America, Inc., USA, MW 3000), graft diol A (44.720 g, 72.56 wt % in ethyl acetate), 17.046 grams of isophorone diisocyanate (IPDI), and 3.481 grams of 2,2-bis(hydroxymethyl)propionic acid (DMPA) in 42 grams of acetone were mixed in a 500 mL 4-neck round bottom flask. A mechanical stirrer with glass rod and TEFLON® (E. I. du Pont de Nemours Company, Delaware) blade was attached. A condenser was attached. The flask was immersed in a constant temperature bath at 60° C. The system was kept under drying tube. 3 drops of DBTDL were added to initiate the polymerization. Polymerization was continued for 3 hours at 60° C. A 0.5-gram sample was withdrawn for wt % NCO titration to confirm the reaction. The measured NCO value was 1.91 wt %. Theoretical wt % NCO was 1.94 wt %. The polymerization temperature was reduced to 40° C. 8.393 grams of sulfonate-containing diamine (A-95™, Evonik, Germany, 50 wt % in water) and 2.180 grams of 50 wt % sodium hydroxide aqueous solution in 20.983 grams of deionized water are mixed in a beaker until A-95™ is completely dissolved. The A-95™ solution was added to the pre-polymer solution at 40° C. with vigorous stirring over 5 minutes. The solution became viscous and slight hazy. The mixture was stirred for 30 minutes at 40° C. Then 180.443 grams of deionized water was added to the polymer mixture in the 4-neck round bottom flask over 10 minutes with good agitation to form a polyurethane dispersion (PUD). The agitation was continued for 60 minutes at 40° C. The PUD was filtered through a 400 mesh stainless sieve. Acetone was removed with Rotorvap at 40° C. (add 2 drops (20 mg) BYK™-011 de-foaming agent, BYK, Germany). The final PUD was filtered through fiber glass filter paper. Particle size measured by Malvern ZETASIZER™ (Malvern Panalytical, United Kingdom) is 83.46 nm. The pH was 7. The solids content was 33.37 wt %. The acid number was 26.9 mg KOH/g.

### Example 12—Synthesis of Polyurethane Binder GPUD-10

11.099 grams of polycarbonate polyol (UBE PH-50, MW 500), graft diol A (69.537 g, 72.56 wt % in ethyl acetate), 26.506 grams of isophorone diisocyanate (IPDI), and 5.414 grams of 2,2-bis(hydroxymethyl)propionic acid (DMPA) in 42 grams of acetone were mixed in a 500 mL 4-neck round bottom flask. A mechanical stirrer with glass rod and TEFLON® (E. I. du Pont de Nemours Company, Delaware) blade was attached. A condenser was attached. The flask was immersed in a constant temperature bath at 60° C. The system was kept under drying tube. 3 drops of DBTDL were added to initiate the polymerization. Polymerization was continued for 3 hours at 60° C. A 0.5-gram sample was withdrawn for wt % NCO titration to confirm the reaction. The measured NCO value was 3.09 wt %. Theoretical wt % NCO was 3.10 wt %. The polymerization temperature was reduced to 40° C. 13.051 grams of sulfonate-containing diamine (A-95™, Evonik, Germany, 50 wt % in water) and 3.390 grams of 50 wt % sodium hydroxide aqueous solution in 32.267 grams of deionized water are mixed in a beaker until A-95™ is completely dissolved. The A-95™ solution was added to the pre-polymer solution at 40° C. with vigorous stirring over 5 minutes. The solution became viscous and slight hazy. The mixture was stirred for 30 minutes at 40° C. Then 164.317 grams of deionized water was added to the polymer mixture in the 4-neck round bottom flask over 10 minutes with good agitation to form a polyurethane dispersion (PUD). The agitation was continued for 60 minutes at 40° C. The PUD was filtered through a 400 mesh stainless sieve. Acetone was removed with Rotorvap at 40° C. (add 2 drops (20 mg) BYK™-011 de-foaming agent, BYK, Germany). The final PUD was filtered through fiber glass filter paper. Particle size measured by Malvern ZETASIZER™ (Malvern Panalytical, United Kingdom) is 66.21 nm. The pH was 7. The solids content was 32.85 wt %. The acid number was 41.9 mg KOH/g.

### Example 13—Synthesis of Polyurethane Binder GPUD-11

11.099 grams of polycarbonate polyol (UBE UH-50, MW 500), graft diol A (69.537 g, 72.56 wt % in ethyl acetate), 26.506 grams of isophorone diisocyanate (IPDI), and 5.414 grams of 2,2-bis(hydroxymethyl)propionic acid (DMPA) in 42 grams of acetone were mixed in a 500 mL 4-neck round bottom flask. A mechanical stirrer with glass rod and TEFLON® (E. I. du Pont de Nemours Company, Delaware) blade was attached. A condenser was attached. The flask was immersed in a constant temperature bath at 60° C. The system was kept under drying tube. 3 drops of DBTDL were added to initiate the polymerization. Polymerization was continued for 3 hours at 60° C. A 0.5-gram sample was withdrawn for wt % NCO titration to confirm the reaction. The measured NCO value was 3.09 wt %. Theoretical wt % NCO was 3.10 wt %. The polymerization temperature was reduced to 40° C. 13.051 grams of sulfonate-containing diamine (A-95™, Evonik, Germany, 50 wt % in water) and 3.390 grams of 50 wt % sodium hydroxide aqueous solution in 32.267 grams of deionized water are mixed in a beaker until A-95™ is completely dissolved. The A-95™ solution was added to the pre-polymer solution at 40° C. with vigorous stirring over 5 minutes. The solution became viscous and slight hazy. The mixture was stirred for 30 minutes at 40° C. Then 164.317 grams of deionized water was added to the polymer mixture in the 4-neck round bottom flask over 10 minutes with good agitation to form a polyurethane dispersion (PUD). The agitation was continued for 60 minutes at 40° C. The PUD was filtered through a 400 mesh stainless sieve. Acetone was removed with Rotorvap at 40° C. (add 2 drops (20 mg) BYK™-011 de-foaming agent, BYK, Germany). The final PUD was filtered through fiber glass filter paper. Particle size measured by Malvern ZETASIZER™ (Malvern Panalytical, United Kingdom) is 49.12 nm. The pH was 7.5. The solids content was 33.21 wt %. The acid number was 41.9 mg KOH/g.

### Example 14—Synthesis of Polyurethane Binder GPUD-12

11.099 grams of polycarbonate polyol (UBE UD-50, MW 500), graft diol A (69.537 g, 72.56 wt % in ethyl acetate), 26.506 grams of isophorone diisocyanate (IPDI), and 5.414 grams of 2,2-bis(hydroxymethyl)propionic acid (DMPA) in 42 grams of acetone were mixed in a 500 mL 4-neck round bottom flask. A mechanical stirrer with glass rod and TEFLON® (E. I. du Pont de Nemours Company, Delaware) blade was attached. A condenser was attached. The flask was immersed in a constant temperature bath at 60° C. The system was kept under drying tube. 3 drops of DBTDL were added to initiate the polymerization. Polymerization was continued for 3 hours at 60° C. A 0.5-gram sample was withdrawn for wt % NCO titration to confirm the reaction. The measured NCO value was 3.09 wt %. Theoretical wt % NCO was 3.10 wt %. The polymerization temperature was reduced to 40° C. 13.051 grams of sulfonate-containing diamine (A-95™, Evonik, Germany, 50 wt % in water) and 3.390 grams of 50 wt % sodium hydroxide aqueous solution in 32.267 grams of deionized water are mixed in a beaker until A-95™ is completely dissolved. The A-95™ solution was added to the pre-polymer solution at 40° C. with vigorous stirring over 5 minutes. The solution became viscous and slight hazy. The mixture was stirred for 30 minutes at 40° C. Then 164.317 grams of deionized water was added to the polymer mixture in the 4-neck round bottom flask over 10 minutes with good agitation to form a polyurethane dispersion (PUD). The agitation was continued for 60 minutes at 40° C. The PUD was filtered through a 400 mesh stainless sieve. Acetone was removed with Rotorvap at 40° C. (add 2 drops (20 mg) BYK™-011 de-foaming agent, BYK, Germany). The final PUD was filtered through fiber glass filter paper. Particle size measured by Malvern ZETASIZER™ (Malvern Panalytical, United Kingdom) is 33.65 nm. The pH was 7. The solids content was 33.65 wt %. The acid number was 41.9 mg KOH/g.

### Example 15—Ink Compositions

Sample ink compositions were prepared using the polyurethane binders of Examples 3-14. The ink compositions included 6 wt % of the respective polyurethane binder dispersion from Examples 3-14, 6 wt % glycerol as an organic co-solvent, 0.5 wt % of CRODAFOS® N3 Acid (available from Croda Personal Care, United Kingdom), 1 wt % of LIPONIC® EG-1 as an organic co-solvent (available from Vantage Specialty Chemicals, Illinois), 0.22 wt % of ACTICIDE® B20 biocide (available from Thor, United Kingdom), 0.3 wt % of SURFYNOL® 440 surfactant (available from Evonik, Germany), and 3 wt % HPF-M046 magenta pigment dispersion (available from DIC Corporation, Japan). The difference between the ink compositions was the selection of the polyurethane binder. A control ink composition was also prepared as a comparative example that included IMPRANIL® DLN-SD (available from Covestro AG, Germany) as the binder. The comparative IMPRANIL® DLN-SD binder does not contain the combination of polymerized graft diol, polymeric diol, acid-containing diol, and sulfonate-containing diamine that is in the polyurethane binders of Examples 3-14.

### Example 16—Crosslinker Composition

A crosslinker composition was prepared for use in some examples hereinafter. For these examples, POLYCUP™ 7360A, which is a polyimine-based azetidinium salt from Solenis (USA), was used underprinted with respect to the ink compositions of the present disclosure. The polyimine-based azetidinium salt content in the crosslinker composition can range from about 3 wt % to 6 wt %, depending on how much is applied relative to the ink composition. The balance can include water, organic co-solvent, and other liquid vehicle components. The pH of the crosslinker composition was acidic, e.g., from about 3 to about 5.

### Example 17—Washfastness

The sample ink compositions of Example 15 were printed onto gray cotton fabric and T-shirt fabric using a test inkjet printer. A set of printed samples was printed using the ink compositions without a fixer composition, and a second set of printed samples was underprinted with a fixer composition prepared in accordance with Example 16. The printed samples were cured by heating at 150° C. for 3 minutes. After printing and heat curing, the printed images were measured initially for optical density (OD). Optical density is measured herein using an X-RITE™ Spectrodensitometer (X-Rite Corporation), such as a Series 500 Densitometer.

To test washfastness, the cured samples were then washed for 5 cycles using a washing machine at 40° C. with detergent and then air dried. The GD after 5 washes was again measured using the same instrument. The % change in optical density (ΔOD) and various ΔE values (CIE, 1994, 2000, and CMC 2:1, as defined previously) were collected to compare the samples before washing and the samples after washing. Tables 1-4 show washfastness data for the inks printed on two different types of gray fabric, with and without fixer composition.

TABLE 1
Ink Composition Printed on Gray Cotton Fabric Without Fixer Composition

| | OD | OD | | | | | |
|---|---|---|---|---|---|---|---|
| | Before | After 5 | ΔOD | | ΔE | | ΔE CMC |
| Binder | Wash | Washes | (%) | ΔE CIE | 2000 | ΔE 94 | 2:1 |
| GPUD-1 | 0.963 | 0.574 | −40.4 | 21.2 | 13.2 | 15.0 | 9.3 |
| GPUD-2 | 0.967 | 0.535 | −44.7 | 24.3 | 15.4 | 17.9 | 10.9 |
| GPUD-3 | 0.966 | 0.856 | −11.4 | 6.4 | 3.4 | 3.8 | 3.0 |
| GPUD-4 | 0.961 | 0.596 | −38.0 | 22.1 | 14.3 | 16.6 | 10.1 |
| GPUD-5 | 0.946 | 0.583 | −38.4 | 19.8 | 12.1 | 13.6 | 8.5 |
| GPUD-6 | 0.967 | 0.619 | −36.0 | 19.6 | 12.1 | 13.7 | 8.5 |
| GPUD-7 | 0.957 | 0.622 | −35.0 | 19.1 | 11.6 | 13.1 | 8.3 |
| GPUD-8 | 0.948 | 0.728 | −23.2 | 12.6 | 7.3 | 8.1 | 5.4 |
| GPUD-9 | 0.955 | 0.785 | −17.8 | 9.7 | 5.3 | 5.8 | 4.1 |
| GPUD-10 | 0.952 | 0.580 | −39.1 | 20.5 | 12.7 | 14.5 | 8.9 |
| GPUD-11 | 0.944 | 0.578 | −38.8 | 19.9 | 12.5 | 14.3 | 8.7 |
| GPUD-12 | 0.940 | 0.619 | −34.1 | 17.8 | 11.0 | 12.5 | 7.8 |
| IMPRANIL ® | 0.954 | 0.730 | −23.5 | 12.8 | 7.4 | 8.2 | 5.5 |
| DLN-SD | | | | | | | |

TABLE 2
Ink Composition Printed on Pakistan #1 T-Shirt Fabric
(50/50 w/w cotton and polyester) Without Fixer Composition

| | OD | OD | | | | | |
|---|---|---|---|---|---|---|---|
| | Before | After 5 | ΔOD | | ΔE | | ΔE CMC |
| Binder | Wash | Washes | (%) | ΔE CIE | 2000 | ΔE 94 | 2:1 |
| GPUD-1 | 1.072 | 0.424 | −60.5 | 36.5 | 22.4 | 25.6 | 15.8 |
| GPUD-2 | 1.076 | 0.371 | −65.5 | 43.8 | 26.4 | 30.5 | 18.9 |
| GPUD-3 | 1.053 | 0.792 | −24.8 | 12.4 | 7.1 | 7.6 | 5.2 |
| GPUD-4 | 1.096 | 0.459 | −58.1 | 35.1 | 22.0 | 25.2 | 15.5 |
| GPUD-5 | 1.080 | 0.599 | −44.5 | 24.5 | 15.1 | 16.5 | 10.6 |
| GPUD-6 | 1.089 | 0.558 | −48.8 | 28.2 | 17.7 | 19.7 | 12.3 |
| GPUD-7 | 1.072 | 0.418 | −61.0 | 38.2 | 23.3 | 26.6 | 16.4 |
| GPUD-8 | 1.053 | 0.503 | −52.3 | 32.0 | 19.4 | 21.8 | 13.6 |
| GPUD-9 | 1.036 | 0.696 | −32.9 | 18.5 | 11.0 | 12.0 | 7.8 |
| GPUD-10 | 1.080 | 0.617 | −42.9 | 24.4 | 15.1 | 16.6 | 10.5 |
| GPUD-11 | 1.076 | 0.567 | −47.4 | 26.5 | 16.3 | 18.1 | 11.4 |
| GPUD-12 | 1.086 | 0.691 | −36.4 | 20.5 | 12.9 | 14.1 | 9.0 |
| IMPRANIL ® | 1.045 | 0.700 | −33.3 | 18.5 | 11.2 | 12.0 | 7.9 |
| DLN-SD | | | | | | | |

TABLE 3
Ink Composition Printed on Gray Cotton Fabric With Fixer Composition

| | OD | OD | | | | | |
|---|---|---|---|---|---|---|---|
| | Before | After 5 | ΔOD | | ΔE | | ΔE CMC |
| Binder | Wash | Washes | (%) | ΔE CIE | 2000 | ΔE 94 | 2:1 |
| GPUD-1 | 0.979 | 0.966 | −1.4 | 2.9 | 1.3 | 1.5 | 1.4 |
| GPUD-2 | 0.990 | 0.990 | −0.1 | 2.8 | 1.2 | 1.5 | 1.4 |
| GPUD-3 | 0.979 | 0.970 | −1.0 | 2.9 | 1.3 | 1.6 | 1.5 |
| GPUD-4 | 0.997 | 0.995 | −0.2 | 3.1 | 1.3 | 1.6 | 1.5 |
| GPUD-5 | 0.983 | 0.963 | −2.1 | 2.9 | 1.3 | 1.6 | 1.5 |
| GPUD-6 | 0.974 | 0.964 | −1.1 | 2.8 | 1.2 | 1.5 | 1.4 |
| GPUD-7 | 0.981 | 0.959 | −2.3 | 2.9 | 1.3 | 1.5 | 1.5 |
| GPUD-8 | 0.981 | 0.976 | −0.5 | 2.6 | 1.1 | 1.3 | 1.3 |
| GPUD-9 | 1.009 | 1.004 | −0.5 | 2.3 | 1.0 | 1.2 | 1.2 |
| GPUD-10 | 0.992 | 0.975 | −1.7 | 2.8 | 1.2 | 1.5 | 1.4 |
| GPUD-11 | 0.985 | 0.955 | −3.0 | 3.1 | 1.6 | 1.8 | 1.5 |
| GPUD-12 | 0.975 | 0.960 | −1.5 | 2.8 | 1.2 | 1.5 | 1.4 |
| IMPRANIL ® | 1.063 | 1.059 | −0.3 | 2.5 | 1.1 | 1.3 | 1.2 |
| DLN-SD | | | | | | | |

TABLE 4
Ink Composition Printed on Pakistan #1 T-Shirt Fabric
(50/50 w/w cotton and polyester) With Fixer Composition

| | OD | OD | | | | | |
|---|---|---|---|---|---|---|---|
| | Before | After 5 | ΔOD | | ΔE | | ΔE CMC |
| Binder | Wash | Washes | (%) | ΔE CIE | 2000 | ΔE 94 | 2:1 |
| GPUD-1 | 1.119 | 1.039 | −7.1 | 3.7 | 2.0 | 2.1 | 1.6 |
| GPUD-2 | 1.053 | 1.008 | −4.3 | 3.6 | 1.7 | 1.8 | 1.5 |
| GPUD-3 | 1.142 | 1.076 | −5.8 | 3.4 | 1.6 | 1.7 | 1.5 |
| GPUD-4 | 1.123 | 1.089 | −3.0 | 2.9 | 1.2 | 1.3 | 1.2 |
| GPUD-5 | 1.126 | 1.054 | −6.4 | 3.2 | 1.7 | 1.8 | 1.4 |
| GPUD-6 | 1.134 | 1.075 | −5.2 | 3.4 | 1.7 | 1.8 | 1.5 |
| GPUD-7 | 1.121 | 1.056 | −5.8 | 3.6 | 1.6 | 1.7 | 1.5 |
| GPUD-8 | 1.067 | 1.045 | −2.1 | 1.5 | 0.7 | 0.8 | 0.7 |
| GPUD-9 | 1.049 | 1.007 | −4.1 | 2.4 | 1.0 | 1.1 | 1.0 |
| GPUD-10 | 1.113 | 1.060 | −4.8 | 2.4 | 1.1 | 1.2 | 1.1 |
| GPUD-11 | 1.107 | 1.027 | −7.2 | 2.7 | 1.3 | 1.4 | 1.2 |
| GPUD-12 | 1.140 | 1.104 | −3.2 | 2.7 | 1.4 | 1.5 | 1.2 |
| IMPRANIL ® | 1.059 | 1.033 | −2.5 | 1.8 | 0.5 | 0.5 | 0.6 |
| DLN-SD | | | | | | | |

The washfastness data in Tables 1-4 demonstrate that all the inks provided good washfastness when used together with the fixer composition. When the inks were printed alone, some inks performed well while others performed acceptably for the most part. GPUD-3 and GPUD-9 provided the best washfastness without the fixer composition.

### Example 18—Ink Composition Stability

An Accelerated Shelf Life (ASL) test and T-cycle test was performed for the ink compositions described above. For the ASL test, the data was collected for the ink compositions before and after 1 week of storage at 60° C. The % Δ data below relates to a comparison prior to ASL storage and after 1 week of storage. For the T-cycle test, the ink compositions were cooled to −50° C. and then warmed to 40° C. This cooling and warming cycle was repeated for 5 total cycles. The data are shown in Table 5. Viscosity refers to the fluid viscosity of the ink compositions, which can be measured at a shear rate of 3,000 Hz, e.g., with a Viscolite Viscometer from Hydramotion (USA). pH refers to the pH of the ink composition and can be measured using an ACCUMET XL250 pH meter, from Fisher Scientific (USA); Mv refers to Volume Averaged D50 Particle Size; and D95 refers to the 95 Percentile Particle Size.

TABLE 5
Ink Composition Stability

| | ASL (1 week at 60° C.) | | | | T-cycle | | | |
|---|---|---|---|---|---|---|---|---|
| | Δ% | | Δ% | Δ% | Δ% | | Δ% | Δ% |
| Binder | Viscosity | Δ pH | Mv | D95 | Viscosity | Δ pH | Mv | D95 |
| GPUD-1 | 0.0 | −0.12 | −2.6 | −4.1 | 0.0 | 0.03 | 0.8 | −6.5 |
| GPUD-2 | −4.5 | −0.10 | −0.7 | 0.3 | −4.5 | 0.03 | −1.9 | 1.6 |
| GPUD-3 | −4.3 | −0.11 | −5.5 | −2.8 | 0.0 | 0.00 | −2.2 | −3.6 |
| GPUD-4 | −7.4 | −0.12 | 1.6 | 0.1 | −3.7 | −0.01 | 0.4 | −0.1 |
| GPUD-5 | 0.0 | −0.16 | 3.5 | −5.9 | 0.0 | −0.02 | −1.1 | −5.8 |
| GPUD-6 | 0.0 | −0.13 | −0.8 | −5.5 | 0.0 | −0.02 | −4.5 | −7.4 |
| GPUD-7 | 0.0 | −0.05 | −3.8 | −3.1 | 0.0 | 0.04 | −5.2 | −3.6 |
| GPUD-8 | 0.0 | −0.10 | −0.4 | −4.2 | 0.0 | 0.03 | −1.9 | −1.7 |
| GPUD-9 | −4.3 | −0.03 | 0.4 | −2.9 | −4.3 | 0.07 | −5.7 | −1.4 |
| GPUD-10 | 0.0 | 0.01 | −1.7 | −1.6 | 0.0 | 0.05 | −5.9 | −2.4 |
| GPUD-11 | 0.0 | −0.05 | −1.7 | −4.7 | 0.0 | 0.05 | −1.4 | −3.4 |
| GPUD-12 | 0.0 | −0.21 | −2.9 | 0.3 | 0.0 | 0.01 | −0.2 | −0.9 |
| IMPRANIL ® | −4.8 | −0.23 | −12.2 | −26.0 | 0.0 | 0.03 | −1.7 | −12.1 |
| DLN-SD | | | | | | | | |

The ASL data show that all of the inks had good ink stability, with better numbers particularly with respect to viscosity and particle size (Mv and D95) relative to the comparative polyurethane Impranil® DLN-SD.

### Example 19—Print Performance

The ink compositions were evaluated for print performance from a thermal inkjet pen (A3410, available from HP, Inc., California). The data was collected according to the following procedures:

Decap is determined using the indicated time (0-9 seconds) where nozzles remain open (uncapped), and then the number of lines missing (or line spits until a good line is printed) during a print event are recorded. Thus, the lower the number the better for decap performance. Table 6 shows data recorder for decap performance.

TABLE 6
Decap Performance

| | Decap | Decap | Decap | Decap | Decap | Decap |
|---|---|---|---|---|---|---|
| Binder | (0 s) | (1 s) | (3 s) | (5 s) | (7 s) | (9 s) |
| GPUD-1 | 1 | 1 | 1 | 1 | 1 | 1 |
| GPUD-2 | 1 | 2 | 5 | 6 | 8 | 13 |
| GPUD-3 | 1 | 1 | 1 | 1 | 1 | 2 |
| GPUD-4 | 1 | 1 | 5 | 10 | 15 | 15 |
| GPUD-5 | 1 | 1 | 1 | 1 | 1 | 2 |
| GPUD-6 | 1 | 1 | 1 | 1 | 1 | 2 |
| GPUD-7 | 1 | 1 | 1 | 2 | 3 | 5 |
| GPUD-8 | 1 | 2 | 3 | 6 | 8 | 15 |
| GPUD-9 | 1 | 3 | 7 | 10 | 15 | 15 |
| GPUD-10 | 1 | 1 | 1 | 1 | 2 | 2 |
| GPUD-11 | 1 | 1 | 1 | 1 | 2 | 3 |
| GPUD-12 | 1 | 1 | 1 | 1 | 1 | 2 |
| IMPRANIL ® | 1 | 1 | 2 | 4 | 7 | 9 |
| DLN-SD | | | | | | |

Percent (%) Missing Nozzles is calculated based on the number of nozzles incapable of firing at the beginning of a jetting sequence as a percentage of the total number of nozzles on an inkjet printhead attempting to fire. Thus, the lower the percentage number, the better the Percent Missing Nozzles value.

Drop Weight (DW) is an average drop weight in nanograms (ng) across the number of nozzles fired measured using a burst mode or firing at 0.75 Joules.

Drop Weight 2,000 (DW 2K) is measured using a 2-drop mode of firing, firing 2,000 drops and then measuring/calculating the average ink composition drop weight in nanograms (ng).

Drop Volume (DV) refers to an average velocity of the drop as initially fired from the thermal inkjet nozzles.

Decel refers to the loss in drop velocity after 5 seconds of ink composition firing.

The missing nozzles, drop weight, drop volume, and decel data are shown in Table 7.

TABLE 7
Missing Nozzle, Drop Weight, Drop
Volume, and Decel Performance

| | Miss. Noz. | DW | DW 2k | DV | |
|---|---|---|---|---|---|
| Binder | (%) | (ng) | (ng) | (m/s) | Decel |
| GPUD-1 | 4.2 | 10.2 | 11.1 | 8.9 | 0.0 |
| GPUD-2 | 6.3 | 8.3 | 6.9 | 6.3 | 0.0 |
| GPUD-3 | 4.2 | 10.8 | 10.6 | 10.7 | 0.0 |
| GPUD-4 | 2.1 | 10.5 | 2.5 | 10.6 | 0.0 |
| GPUD-5 | 1.0 | 9.5 | 10.0 | 7.8 | 0.0 |
| GPUD-6 | 0.0 | 8.9 | 10.6 | 8.7 | 0.0 |
| GPUD-7 | 2.1 | 9.1 | 9.3 | 6.9 | 0.0 |
| GPUD-8 | 50.0 | 6.8 | 5.3 | 4.2 | 0.0 |
| GPUD-9 | 56.3 | 5.2 | 4.3 | 3.9 | 0.0 |
| GPUD-10 | 2.1 | 9.5 | 10.0 | 7.8 | 1.0 |
| GPUD-11 | 2.1 | 9.4 | 10.2 | 7.6 | 1.5 |
| GPUD-12 | 5.2 | 10.1 | 11.1 | 8.1 | 0.0 |
| IMPRANIL ® | 1.0 | 9.2 | 8.5 | 8.0 | 2.0 |
| DLN-SD | | | | | |

The ink with GPUD-3 was found to have the best combination of print performance, ink stability, and washfastness. The ink that included GPUD-3 was also found to have a good TOE curve and good sustained printing without services the print nozzles. Accordingly, while many of the sample polyurethane binders were found to have good characteristics, GPUD-3 in particular was found to have the best combination of properties for textile printing.

What is claimed is:

1. An ink composition, comprising:
water;
an organic co-solvent;
a colorant; and
a polyurethane binder comprising:
pre-polymer segments including polymerized monomers of a diisocyanate, a graft diol, a polymeric diol, and an acid-containing diol, wherein the graft diol includes thioglycerol having a polymer sidechain replacing a hydrogen atom on a sulfur atom of the thioglycerol, and wherein the polymer sidechain includes a polymerized monomer of an acrylate ester, a methacrylate ester, a styrene, or a combination thereof, and
chain extenders connecting the pre-polymer segments, wherein the chain extenders include a polymerized sulfonate-containing diamine.

2. The ink composition of claim 1, wherein the polymeric diol includes a first terminal hydroxyl group at a first end of the polymeric diol and a second terminal hydroxyl group at a second end of the polymeric diol.

3. The ink composition of claim 1, wherein the acid-containing diol is 2,2-bis(hydroxymethyl) propionic acid or 2,2-bis(hydroxymethyl) butyric acid.

4. The ink composition of claim 1, wherein the graft diol includes structure: 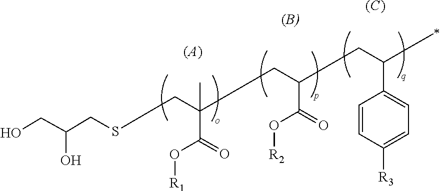
where R₁ is C1-C12 alkyl or C6-C16 cycloalkyl, R₂ is C1-C12 alkyl or C6-C16 cycloalkyl, and R₃ is a H, C1-C12 alkyl or C6-C16 cycloalkyl, where polymerized monomers (A), (B), and (C), if independently present, are polymerized in a random copolymer sidechain, and where o, p, and q are independently 0 to 200, provided that o+p+q is from 5 to 200.

5. The ink composition of claim 1, wherein the polymer sidechain of the graft diol is a random copolymer of methyl methacrylate and 2-ethylhexyl acrylate.

6. The ink composition of claim 1, wherein the graft diol has a weight average molecular weight from 500 Mw to 15,000 Mw.

7. The ink composition of claim 1, wherein the diisocyanate comprises 2,2,4-trimethylhexane-1,6-diisocyanate, 2,4,4-trimethylhexane-1,6-diisocyanate, isophorone diisocyanate, 1,3-bis(isocyanatomethyl)cyclohexane, hexamethylene diisocyanate, methylene diphenyl diisocyanate, 4,4′-methylene dicyclohexyl diisocyanate, or a combination thereof.

8. The ink composition of claim 1, wherein the polyurethane binder has an acid number from 10 mg KOH/g to 100 mg KOH/g.

9. A textile printing system, comprising:
a fabric substrate; and
an ink composition, comprising:
water,
an organic co-solvent,
a colorant, and
a polyurethane binder comprising:
pre-polymer segments including polymerized monomers of a diisocyanate, a graft diol, a polymeric diol, and an acid-containing diol, wherein the graft diol includes thioglycerol having a polymer sidechain replacing a hydrogen atom on a sulfur atom of the thioglycerol, and wherein the polymer sidechain includes a polymerized monomer of an acrylate ester, a methacrylate ester, a styrene, or a combination thereof, and
chain extenders connecting the pre-polymer segments, wherein the chain extenders include a polymerized sulfonate-containing diamine.

10. The textile printing system of claim 9, wherein the fabric substrate includes cotton, polyester, silk, nylon, or a blend thereof.

11. The textile printing system of claim 9, wherein the graft diol includes structure: 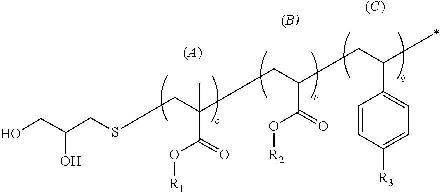
where R₁ is C1-C12 alkyl or C6-C16 cycloalkyl, R₂ is C1-C12 alkyl or C6-C16 cycloalkyl, and R₃ is a H, C1-C12 alkyl or C6-C16 cycloalkyl, where polymerized monomers (A), (B), and (C), if independently present, are polymerized in a random copolymer sidechain, and where o, p, and q are independently 0 to 200, provided that o+p+q is from 5 to 200.

12. The textile printing system of claim 9, further comprising a crosslinker composition including a crosslinker that is reactive with the polyurethane binder to crosslink the polyurethane binder after printed in contact with the ink composition on the fabric substrate.

13. A method of textile printing, comprising:
jetting an ink composition onto a fabric substrate, the ink composition comprising:
water,
an organic co-solvent,
a colorant, and
a polyurethane binder comprising:
pre-polymer segments including polymerized monomers of a diisocyanate, a graft diol, a polymeric diol, and an acid-containing diol, wherein the graft diol includes thioglycerol having a polymer sidechain replacing a hydrogen atom on a sulfur atom of the thioglycerol, and wherein the polymer sidechain includes a polymerized monomer of an acrylate ester, a methacrylate ester, a styrene, or a combination thereof, and
chain extenders connecting the pre-polymer segments, wherein the chain extenders include a polymerized sulfonate-containing diamine.

14. The method of claim 13, further comprising applying a crosslinker composition onto the fabric substrate before jetting the ink composition.

15. The method of claim 13, wherein the graft diol includes structure: 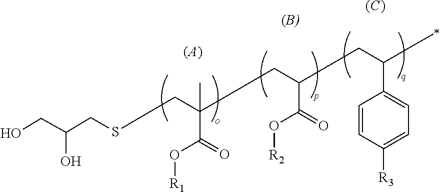
where R₁ is C1-C12 alkyl or C6-C16 cycloalkyl, R₂ is C1-C12 alkyl or C6-C16 cycloalkyl, and R₃ is a H, C1-C12 alkyl or C6-C16 cycloalkyl, where polymerized monomers (A), (B), and (C), if independently present, are polymerized in a random copolymer sidechain, and where o, p, and q are independently 0 to 200, provided that o+p+q is from 5 to 200.
